(19) United States
(12) Patent Application Publication
(10) Pub. No.: US 2026/0342679 A1
(43) Pub. Date: Oct. 29, 2026

(54) WIRELESS COMMUNICATION METHOD FOR APPLYING AI/ML FUNCTIONALITIES AND RELATED DEVICES

(71) Applicant: PURPLEVINE INNOVATION COMPANY LIMITED, HONG KONG (CN)

(72) Inventor: Chiu-Wen CHEN, HONG KONG (CN)

(73) Assignee: PURPLEVINE INNOVATION COMPANY LIMITED, HONG KONG (CN)

(21) Appl. No.: 19/700,085

(22) Filed: Jun. 5, 2026

Related U.S. Application Data
(63) Continuation of application No. PCT/CN2024/137250, filed on Dec. 5, 2024.
(60) Provisional application No. 63/606,102, filed on Dec. 5, 2023.

(51) Int. Cl. H04L 41/16; H04L 43/062

(52) U.S. Cl. CPC H04L 41/16; H04L 43/062

(57) ABSTRACT

A wireless communication method for applying AI/ML functionalities and related devices is provided. The method, performed by the UE, includes sending, by a UE in a network, artificial intelligence (AI)/machine learning (ML) capability information to the network, wherein the AI/ML capability information indicates supported AI/ML functionalities at UE side; communicating with the network to decide applicable AI/ML functionality for AI/ML feature/feature group (FG), at least based on the AI/ML capability information; and performing at least one AI/ML functionality activation at a given time to trigger AI/ML inference for mobility management and seamless data transmission. With this method, intelligent mobility management can be realized.

### CROSS-REFERENCE TO RELATED APPLICATIONS

This application is a continuation of International Application No. PCT/CN2024/137250, filed on Dec. 5, 2024, which claims priority to US Patent Application No. 63/606,102, filed on Dec. 5, 2023, the entire contents of each of which are incorporated herein by reference.

### TECHNICAL FIELD

The present disclosure relates to the field of wireless communications, and more particularly, to a wireless communication method for applying AI/ML functionalities and related devices.

### BACKGROUND ART

Communication systems and networks have developed towards being a broadband and mobile system. In cellular wireless communication systems developed by the Third Generation Partnership Project (3GPP), user equipment (UE) is connected by a wireless link to a next generation radio access network (NG-RAN). The NG-RAN includes a set of base stations (BSs) which provide wireless links to the UEs located in cells covered by the base station, and the interface(s) to a core network (CN) which provides overall network control. The 3GPP has developed the so-called 4G or Long-Term Evolution (LTE) system, namely, an Evolved Universal Mobile Telecommunication System Territorial Radio Access Network (E-UTRAN), for a mobile access network where one or more macro-cells are supported by a base station known as an eNodeB or eNB (evolved NodeB). More recently, evolved from LTE, the so-called 5G or new radio (NR) systems where one or more cells are supported by a base station known as a gNB.

As 5G or NR system is becoming pervasive across industries and geographical areas, handling more advanced services and applications requiring very high data rates (e.g., XR), networks are being denser, use more antennas, larger bandwidths, and more frequency bands. Beyond 5G (B5G) or 6G will be able to use higher frequencies than 5G and provide substantially higher capacity. Artificial intelligence and machine learning (AI/ML) is expected to facilitate large improvements in the presence technology and mobility awareness.

In high-speed mobile 5G/6G and further release cellular communication networks, the UE may experience degradation in radio conditions due to the doppler effect and fast fading. The traditional mobility management procedure (e.g., handover, cell switch) is not performed smoothly enough to adapt to large channel variations in extreme mobility scenarios. Furthermore, the usage of the higher frequency in the cell will cause smaller coverage and it will further cause frequent handover or cell switch. A non-negligible service interruption due to the frequent change of cell would be aggravated. Therefore, there is a need to develop a new mobility management procedure for the UE to optimize service continuity in this field.

### SUMMARY

An object of the present disclosure is to propose a wireless communication method for applying AI/ML functionalities, a method for managing mobility of UE in a network, and related devices (such as a user equipment (UE) and/or a base station (BS)), which can solve issues in the prior art, realize intelligent mobility management, prevent frequent handover or cell switch, realize energy saving or load balancing, and/or provide a good communication performance.

In a first aspect of the present disclosure, provided is a wireless communication method for applying AI/ML functionalities, executable by a user equipment (UE), the method including sending, by a UE in a network, artificial intelligence (AI)/machine learning (ML) capability information to the network, wherein the AI/ML capability information indicates supported AI/ML functionalities at UE side; communicating with the network to decide applicable AI/ML functionality for AI/ML feature/feature group (FG), at least based on the AI/ML capability information; and performing at least one AI/ML functionality activation at a given time to trigger AI/ML inference for mobility management and seamless data transmission.

In a second aspect of the present disclosure, provided is a wireless communication method for applying AI/ML functionalities, executable by a base station (BS), the method including receiving from a UE in a network artificial intelligence (AI)/machine learning (ML) capability information, wherein the AI/ML capability information indicates supported AI/ML functionalities at UE side; communicating with the UE to decide applicable AI/ML functionality for AI/ML feature/feature group (FG), at least based on the AI/ML capability information; and performing at least one AI/ML functionality activation at a given time to trigger AI/ML inference for mobility management and seamless data transmission.

In a third aspect of the present disclosure, a user equipment includes a memory and a processor coupled to the memory, the processor configured to call and run program instructions stored in a memory, to execute the method of the first aspect.

In a fourth aspect of the present disclosure, a base station includes a memory and a processor coupled to the memory, the processor configured to call and run program instructions stored in a memory, to execute the method of the second aspect.

In a fifth aspect of the present disclosure, a non-transitory machine-readable storage medium has stored thereon instructions that, when executed by a computer, cause the computer to perform any of the above methods.

In a sixth aspect of the present disclosure, a chip includes a processor, configured to call and run a computer program stored in a memory, to cause a device in which the chip is installed to execute any of the above methods.

In a seventh aspect of the present disclosure, a computer readable storage medium, in which a computer program is stored, causes a computer to execute any of the above methods.

In an eighth aspect of the present disclosure, a computer program product includes a computer program, and the computer program causes a computer to execute any of the above methods.

In a ninth aspect of the present disclosure, a computer program causes a computer to execute any of the above methods.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram illustrating a communication controlling system according to an embodiment of the present disclosure.

FIG. 1B is a block diagram of a user equipment and a base station of wireless communication in a communication controlling system according to an embodiment of the present disclosure.

FIG. 2 is a schematic diagram illustrating radio protocol architecture within gNB and UE for AI/ML.

FIG. 3 is a schematic diagram illustrating a gNB further including a centralized unit (CU) and a plurality of distributed unit (DUs).

FIG. 4 is a schematic diagram illustrating a general functional AI/ML framework for RAN intelligence according to an embodiment of the present disclosure.

FIG. 5 is a flowchart of a wireless communication method for applying AI/ML functionalities according to an embodiment of the present disclosure.

FIG. 6 is a flowchart of a method for managing mobility of a UE in a network according to an embodiment of the present disclosure.

FIG. 7 is a flowchart of intelligent handover or cell switch according to a first embodiment of the present disclosure.

FIG. 8 is a flowchart of intelligent handover or cell switch according to a second embodiment of the present disclosure.

FIG. 9 is a flowchart of intelligent handover or cell switch according to a third embodiment of the present disclosure.

FIG. 10 is a flowchart of intelligent handover or cell switch according to a fourth embodiment of the present disclosure.

FIG. 11 is a flowchart of intelligent handover or cell switch according to a fifth embodiment of the present disclosure.

FIG. 12 is a flowchart of intelligent handover or cell switch according to a sixth embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In this document, the term "/" should be interpreted to indicate "and/or." A combination such as “at least one of A, B, or C,” “one or more of A, B, or C,” “at least one of A, B, and C,” “one or more of A, B, and C,” or “A, B, and/or C” may be A only, B only, C only, A and B, A and 30 C, B and C, or A and B and C, where any combination may contain one or more members of A, B, or C.

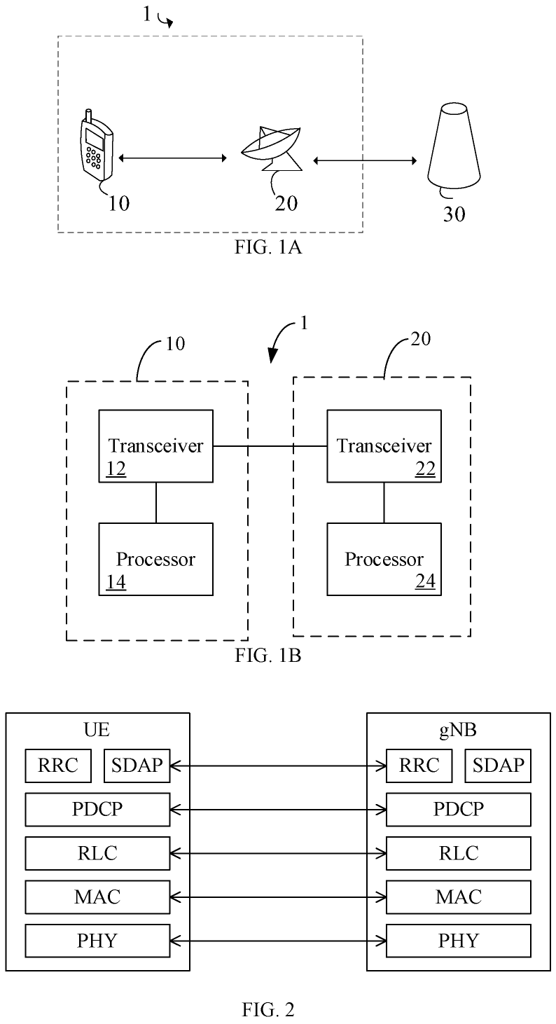

A schematic view and a functional block diagram of a communication controlling system 1 (e.g., 5GS, 6GS) according to the present disclosure are shown in FIGS. 1A and 1B respectively. The communication controlling system 1 includes a user equipment 10 and a base station 20. The user equipment 10 and the base station 20 may communicate with each other either wirelessly or in a wired way. The base station 20 and a next generation core network 30 may also communicate with each other either wirelessly or in a wired way. When the communication controlling system 1 complies with the New Radio (NR) standard of the 3rd Generation Partnership Project (3GPP), the next generation core network (5GCN) 30 is a backend serving network system and may include an Access and Mobility Management Function (AMF), User Plane Function (UPF), and a Session Management Function (SMF).

The user equipment 10 may be an AI/ML-capable UE or non-AI/ML UE while the base station 20 may be an intelligent NG-RAN node or legacy NG-RAN node, but the present disclosure is not limited to this. Both the AI/ML-capable UE and intelligent NG-RAN node support Artificial Intelligence (AI)/Machine Learning (ML) capabilities and techniques whereas AI/ML is not supported by the non-AI/ML UE and legacy NG-RAN node.

The user equipment 10 includes at least one transceiver 12 and a processor 14, which are electrically connected with each other. The base station 20 includes a transceiver 22 and a processor 24, which are electrically connected with each other. The transceiver 12 of the user equipment 10 is configured to transmit a signal to the base station 20 (and receive a signal from the base station 20) and the processor 24 of the base station 20 processes the signal, the transceiver 22 of the base station 20 is configured to transmit a signal to the user equipment 10 (and receive a signal from the user equipment 10) and the processor 14 of the user equipment 10 processes the signal. In this way, the user equipment 10 communicates with the base station 20 each other.

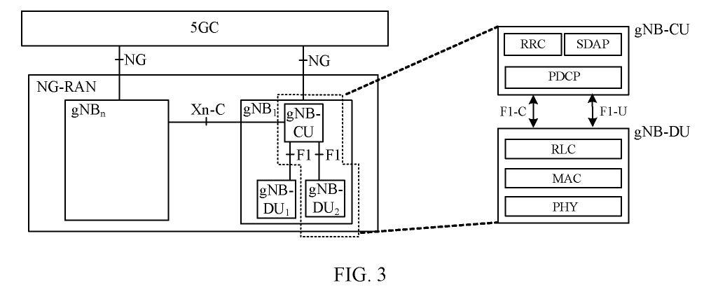

The radio protocol architecture within the base station (gNB) and UE is shown in FIG. 2, which includes Radio Resource Control (RRC), Service Data Adaptation Protocol (SDAP), Packet Data Convergence Protocol (PDCP), Radio Link Control (RLC), Medium Access Control (MAC). RAN functional split is supported for new radio and further generation mobile networks. The new radio protocol architecture within the base station (gNB) and the UE for RAN functional split is shown in FIG. 3, which includes SDAP, RRC, PDCP, RLC, MAC. In case of RAN functional split, the gNB further includes a centralized unit (CU) and a plurality of distributed unit (DUs) as shown in FIG. 3. The protocol stack of CU includes an RRC layer, a SDAP layer, and a PDCP layer, while the protocol stack of DU includes an RLC layer, a MAC layer, and a PHY layer. The F1 interface between the CU and DU is established between the PDCP layer of the protocol stack and the RLC layer of the protocol stack.

An AI/ML-based mobility management is proposed in this disclosure. The AI/ML-capable UE and intelligent NG-RAN are expected to enable the AI/ML techniques including UE-side, network-side, two-side model to manage UE mobility for reducing interruption time and improving network throughput.

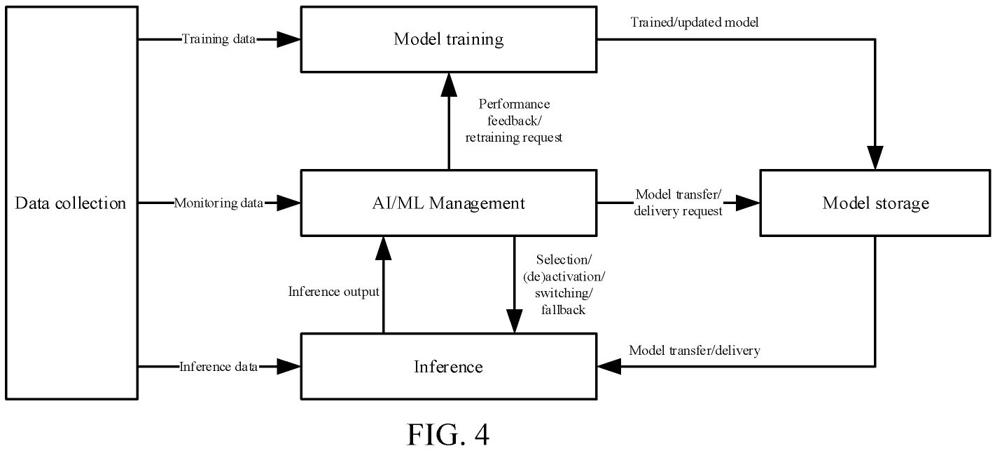

In 5G and further generation mobile networks, AI/ML capabilities are used in various domains in 5GS, including management and orchestration (e.g., management data analytics, MDA), 5GC (e.g., network data analytics function, NWDAF), and NG-RAN (e.g., RAN intelligence). A general functional AI/ML framework for RAN intelligence corresponding to each target use case is shown in FIG. 4. The general AI/ML framework consists of Data Collection, Model Training, Management, Inference, and Model Storage.
A process of data collection performed by the UE/NG-RAN node(s) is used to produce the training data, monitoring data, and inference data for AI/ML model training, data analytics, and inference. In some cases, the UE can transmit a request for data collection. In some embodiments, the network (e.g., gNB, 5GC, OAM, OTT server) can configure associated AI/ML applicable configuration (e.g., intelligent measurement and reporting configuration) to the UE for starting/stopping AI/ML data collection, training, and inference.
The model training process by learning online and offline collecting data/training data/performance feedback dataset is used to train an AI/ML model in a data driven manner and obtain the trained AI/ML model for storage and inference. Online training means the model being used for inference is trained in real-time with the online training data while offline training means the model is trained based on the offline training data, and the trained model is used to generate dataset and/or to deliver trained/updated model for inference. A subprocess of training, model testing, to evaluate the performance of an AI/ML model testing data different from that used for model training and validation. If the testing result does not meet expectations, the AI/ML model needs to be retrained. AI/ML model fine-tuning/retraining can be done via online or offline training. The model training process can be triggered by the (re)training request from the management process to start AI/ML data collection. In some embodiments, model training can be trained across multiple distributed edge nodes (e.g., UEs, NG-RAN nodes, AI/ML entities) each performing local model training by using local training data.
The management process includes the AI/ML life cycle management (LCM), which is associated with data collection, model (re)training, functionality/model identification, model transfer, inference operation, monitoring, and update. In model-ID-based LCM, models are identified at the UE/NG-RAN node via model ID for model selection/(de)activation/switch/fallback. Model-ID-based LCM operates based on identified models via 3GPP signaling (e.g., NAS, RRC, MAC-CE, UCI, DCI, L1, LPP, UAI), where a model may be associated with the specific configuration(s)/condition(s) indicated by UE capability of an AI/ML-enabled Feature/FG and additional condition(s) (e.g., scenarios, monitoring data) as determined/identified between UE and networks. In functionality-based LCM, the UE/network can indicate the selection/(de)activation/switching/fallback of AI/ML functionality via 3GPP signaling (e.g., NAS, RRC, MAC-CE, UCI, DCI, L1, LPP, UAI). An AI/ML functionality refers to an AI/ML-enabled Feature/FG enabled by configuration(s)/condition(s) indicated by UE capability. For network-initiated/UE-initiated/event-triggered model selection/(de)activation/switching, the decision may be made by UE and/or networks.
The inference process is triggered based on the inference data and some conditions (e.g., request by subscription, model/functionality activation, model transfer/delivery). In some embodiments, a gNB can transfer/deliver the inference/prediction result of AI/ML model/functionality to the subscripted UE via 3GPP signaling (e.g., RRC, MAC-CE, DCI/UCI, L1, LPP, UAI), and vice versa. It should be noted that the inference result is interchangeable with predicted result, and they may have similar or the same meaning and may be directed to the same thing in this disclosure. In some cases, when the AI/ML functionality corresponds to at least one of AI/ML models, the AI/ML model is transferred/delivered from 5GC to the subscripted UE via NAS signaling. In some other cases, the AI/ML model is transferred/delivered from OTT server/OAM to the UE. In some further cases, the model transfer/delivery is not expected when the inference is included in the model training process. The inference result can be used as the performance feedback of model training through AI/ML management control. The inference result of the AI/ML model/functionality for AI/ML inference/prediction may be a probability or an indication of the associated event within a given time duration.
The model storage process is based on the mapping of functionality to the physical entity. The AI/ML model can be stored at UE/network side while the trained/updated/transferred model is derived. When the AI/ML model is stored at the network side (e.g., OTT server, OAM, 5GC, gNB) and inference is located at UE side, model transfer/delivery would be performed via 3GPP signaling (e.g., NAS, RRC, MAC-CE, UCI, DCI, L1, LPP, UAI).

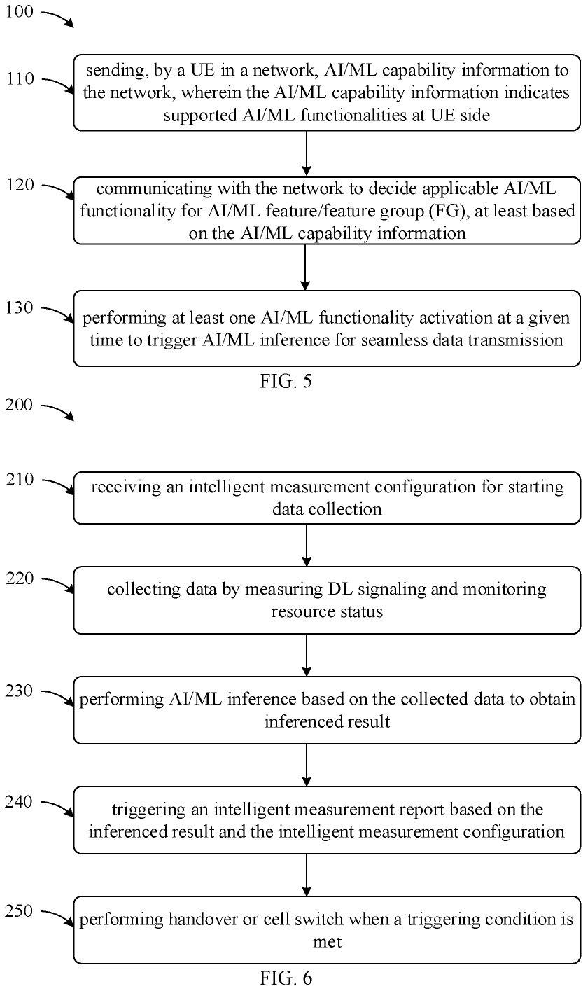

FIG. 5 illustrates a wireless communication method 100 for applying AI/ML functionalities according to an embodiment of the present disclosure. The method 100 is executable by a user equipment (UE) in a network and includes the following.

In Step S110, the UE sends artificial intelligence (AI)/machine learning (ML) capability information to the network, wherein the AI/ML capability information indicates supported AI/ML functionalities at UE side. The AI/ML capability information may be sent via UE-assistance signaling. The UE-assistance signaling may include at least one of the following: radio resource control (RRC) signaling and non-access stratum (NAS) signaling. In some cases, the AI/ML capability information may be sent by the UE upon reception of an AI/ML capability enquiry including AI/ML-enabled Feature/FG associated information.

In Step 120, the UE communicates with the network to decide applicable AI/ML functionality for AI/ML feature/feature group (FG), at least based on the AI/ML capability information. The UE may report the applicable AI/ML functionality via real-time report framework based on the AI/ML capability information and applicable condition. In some cases, the AI/ML capability information may include applicable condition of the AI/ML functionality. Alternatively, the UE may receives applicable condition from the network in response to the AI/ML capability information. Then, the applicable AI/ML functionality may be decided by the UE or the network based on the AI/ML capability information and applicable condition. Further, the UE may receive an AI/ML configuration associated with the applicable AI/ML functionality.

In Step 130, the UE performs at least one AI/ML functionality activation at a given time to trigger AI/ML inference for seamless data transmission. In some cases, at least one of selection, (de)activation, switching and fallback of the AI/ML functionality may be indicated by the UE or the network. The selection, (de)activation, switching or fallback of the AI/ML functionality may be indicated via at least one of the following signaling: NAS, RRC, media access control control element (MAC-CE), uplink control information (UCI), downlink control information (DCI), layer 1 (L1), Long Term Evolution (LTE) positioning protocol (LPP) and UE assistance information (UAI). In some cases, the AI/ML functionality may correspond to an AI/ML model associated with at least one of network configuration and additional condition of the AI/ML Feature/FG. In one deployment, the AI/ML model may be a UE-side model that the AI/ML inference is performed entirely at UE side. Alternatively, the AI/ML model may be a network-side model that the AI/ML inference may be performed entirely at network side. In another deployment, the AI/ML model may be a two-sided model that the AI/ML inference is performed jointly across the UE and the network. In some cases, the AI/ML model may be transferred from the network to the UE. In some cases, the AI/ML model is a UE-side model or a part of a two-sided model, which may be transferred from the UE to the network. In some cases, the AI/ML model may be identified at UE side or network side via model ID. The model ID may be used for at least one of the following model operations: model selection, model activation, model deactivation, model switch and model fallback. The model selection, model activation, model deactivation, model switch or model fallback may be indicated via at least one of the following signaling: NAS, RRC, MAC-CE, UCI, DCI, L1, LPP, UAI. In some cases, inference result of the AI/ML model may be used as performance feedback to train the AI/ML model. In some cases, inference result of the AI/ML model from the UE, a centralized unit (CU) or a distributed unit (DU) of a base station may be used to trigger layer 1 (L1)/layer 2 (L2)-based intelligent mobility management procedure.

With the proposed method 200 illustrated above, since the AI/ML inference for seamless data transmission can be triggered upon AI/ML functionality activation, the invention realizes intelligent mobility management.

FIG. 6 illustrates a method 200 for managing mobility of a UE in a network according to an embodiment of the present disclosure. The method 200 is executable by a user equipment (UE) in a network and includes the following.

In Step 210, the UE receives an intelligent measurement configuration for starting data collection. In this step, the intelligent measurement configuration is configured by the network for the UE to start data collection.

In Step 220, the UE collects data by measuring downlink (DL) signaling and monitoring resource status. In this step, the UE performs measurements on DL signaling and monitors resource status to collect online or offline data. Other additional data may also be collected in this step for being used for AI/ML inference.

In Step 230, the UE performs artificial intelligence (AI)/machine learning (ML) inference based on the collected data to obtain inference result. In some cases, at least one AI/ML functionality may be applicable for AI/ML feature/feature group (FG) associated with mobility management for the AI/ML inference. The AI/ML functionality may correspond to an AI/ML model associated with at least one of network configuration and additional condition of the AI/ML Feature/FG. In some cases, at least one AI/ML model may be applicable for AI/ML feature/FG associated with mobility management for the AI/ML inference. In some cases, the UE may train the AI/ML model using online or offline data. The training of the AI/ML model may be triggered by a retraining request. In some cases, the UE may update the AI/ML model based on the inference result and send the updated AI/ML model including additional condition to the network for AI/ML mobility preparation. In one deployment, the AI/ML model is a UE-side model, and the AI/ML inference may be performed with the UE-side model entirely at UE side. In another deployment, the AI/ML model is a two-sided model, and the AI/ML inference may be performed with the two-sided model jointly across the UE and the network. More specifically, in one embodiment, the AI/ML inference may be performed according to measured measurements and historical information to obtain the inference result, and the inference result includes at least one of predicted signal-to-noise and interference ratio (SINR), reference signal received power (RSRP) and reference signal received quality (RSRQ). The inference result can be cell level or beam level. In another embodiment, the AI/ML inference may be performed according to a difference between measured measurements and inferenced measurement result to obtain the inference result, and the inference result includes at least one of the followings: UE location prediction, UE trajectory prediction, target radio access network (RAN) node prediction, radio resource management (RRM) measurement prediction, radio link failure (RLF) prediction and handover (HO) failure prediction. The inference result may be sent to the network via at least one of the following signaling: non-access stratum (NAS), radio resource control (RRC), media access control control element (MAC-CE), uplink control information (UCI), layer 1 (L1), Long Term Evolution (LTE) positioning protocol (LPP) and UE assistance information (UAI).

In Step 240, the UE triggers an intelligent measurement report based on the inference result and the intelligent measurement configuration. In this step, the intelligent measurement report may be triggered based on the inference result and the intelligent measurement configuration and sent from the UE to the network.

In Step 250, the UE performs handover or cell switch when a triggering condition is met. In some cases, layer 3 (L3)-based intelligent handover or cell switch may be initiated by the UE based on the inference result. Alternatively, L3-based intelligent handover or cell switch is initiated by the network based on the inference result. In some cases, layer 1 (L1)/layer 2 (L2)-based intelligent handover or cell switch may be initiated by the UE based on the inference result. Alternatively, L1/L2-based intelligent handover or cell switch is initiated by the network based on the inference result. In some cases, the UE may transmit a L1/L2 signaling to inform the network of the L1/L2-based intelligent handover or cell switch when the triggering condition of the L1/L2-based intelligent handover or cell switch is met. Then, the UE may receive a response from the network via the L1/L2 signaling for the following seamless data transmission. The triggering condition may include at least one of the following: a SINR threshold, a RSRP threshold, a RSRQ threshold, a threshold of SINR difference, a threshold of RSRP difference and a threshold of RSRQ difference. In some embodiments, the UE may receive network energy saving or load balancing configuration from the network, and the AI/ML inference performing step may include performing the AI/ML inference with the AI/ML mode based on the collected data retrieved according to network energy saving or load balancing strategy corresponding to the network energy saving or load balancing configuration.

With the proposed method 200 illustrated above, the invention can realize intelligent mobility management and further prevent frequent handover or cell switch. In some embodiments, network energy saving or network load balancing can be achieved.

In general, an AI/ML feature refers to a feature that AI/ML would be used. There may be at least one AI/ML model/functionality enabled for the AI/ML feature. A UE may have one or multiple operated AI/ML models/functionalities at a given time. A UE-side model refers to an AI/ML model that inference is performed entirely at the UE side while network-side model is inferenced entirely at the network side. Two-sided model refers to an AI/ML model that inference is performed jointly across the UE and the network, e.g., the first part of inference is performed by the UE and then the remaining part is performed by the gNB. The AI/ML model/functionality should be transferred from the network to the UE for supporting AI/ML-based approach at UE side. The UE capability and AI/ML capability information exchange can be considered to facilitate AI/ML model delivery. For example, in UE-side model or UE part of two-sided model where the model is transferred from the UE to the network, UE initially reports its AI/ML capability (e.g., supported model structure, applicable conditions) via UE-assistance (e.g., UECapability report, LPP) and then indicates the applicable/non-applicable functionality via real-time report framework (e.g., CSI, UAI, NeedForGap). Then at least one of AI/ML models is configured for the network/the UE when the AI/ML functionality corresponds to at least one of AI/ML models. The network may configure the AI/ML-enabled feature and the applicable condition for the UE. The UE may apply the associated actions when the AI/ML-enabled feature and the applicable condition(s) are met based on the network configuration. In some embodiments, the applicable conditions are either determined by UE-side model or configured together with the transferred model from the network for the model selection at UE side. The UE informs the network the model selection/(de)activation/switching/fallback if necessary.

For the high-frequency network (e.g., 5G, 6G), the smaller cell coverage results in the more frequent handover, especially in high-mobility scenarios. Such denser network brings the higher energy consumption and interference. To deal with issues as stated above, AI/ML framework and technologies could be used to facilitate the system performance by collecting and leveraging the online and offline data/dataset in the network. In case of AI/ML-enabled feature (e.g., intelligent mobility), an efficient AI/ML model (e.g., an intelligent mobility management model, IMM) can be deployed and trained through at least one edge node (e.g., UE, NG-RAN node, AI/ML entities) for predicting UE location/UE trajectory/UL traffic/cell load/resource utilization/RRM measurement/RLF/HO failure. UE-side model, network-side model, and two-sided model should be considered. Model transfer/delivery/selection/(de)activation/switch/fallback would be performed via 3GPP signaling (e.g., NAS, RRC, MAC-CE, UCI, DCI, L1, LPP, UAI). The network and/or UE could dynamically configure the handover strategy, network energy saving strategy, or load balance strategy based on the data-driven AI/ML model.

To facilitate and support AI/ML mobility in 5G and further generation radio networks, at least one edge node (e.g., UE, NG-RAN) can be considered to manage mobility by using the efficient AI/ML model. The AI/ML model training, management, and inference for UE location/UE trajectory can be performed in either UE side, NG-RAN side, or both. In case of RAN functional split architecture, AI/ML model training and/or inference can be performed in either gNB-CU or gNB-DU. In some embodiments, the inference results can be used to facilitate L3-based (e.g., radio resource control, RRC) mobility management. In some embodiments, the inference result from UE, gNB-CU, or gNB-DU can be used to trigger the L1/L2-based intelligent mobility management procedure. For example, the serving NG-RAN node may provide the UE with the intelligent measurement configuration for triggering radio and inferenced/predicted measurement reports. Cell/beam level mobility or UE location/UE trajectory can be predicted in the lower layer (e.g., PHY, L1/L2) based on the difference between inference results and the measured/received measurements (e.g., SINR, RSRP, RSRQ). In other words, one case of the inference results (e.g., predicted cell/beam-level SINR, RSRP, RSRQ, etc.) is obtained based on the measured measurements and historical information. The other case of the inference results (e.g., predicted cell/beam-level mobility, UE location, UE trajectory, etc.) is obtained based on a difference between measured measurements and inferenced measurement result (e.g., predicted SINR, RSRP, RSRQ). When the triggering conditions (e.g., a RSRP threshold, a threshold of RSRP difference) are met, the UE/network can initiate L1/L2-based intelligent mobility management based on the inference result and deal with lower layers by means of physical layer and medium access control layer signaling (e.g., UCI, DCI, pre-configured preamble, MAC-CE). During some mobility scenarios (e.g., intra-DU mobility), such L1/L2-based intelligent mobility management helps to reduce more latency and interruption time because the user plane is continued (i.e., without reset) and the security is not updated. In some embodiments, a local edge training and/or inference (e.g., multicasting/broadcasting the inferenced data to UE-side or UE-part of two-sided model inference) using automated distributed computing can be considered to increase AI/ML model accuracy and decrease data transmission latency.

Six embodiments are proposed in the following. The first, second and third embodiments are proposed to serve a case where a UE performs handover from a serving base station serving the UE to a target base station. The fourth, fifth and sixth embodiments are proposed to serve a case where the UE connects to at least two base stations simultaneously (e.g., via Dual-Connectivity or Multi-Connectivity) and performs cell switch from the secondary base station to another base station while the connection to the primary base station is maintained.

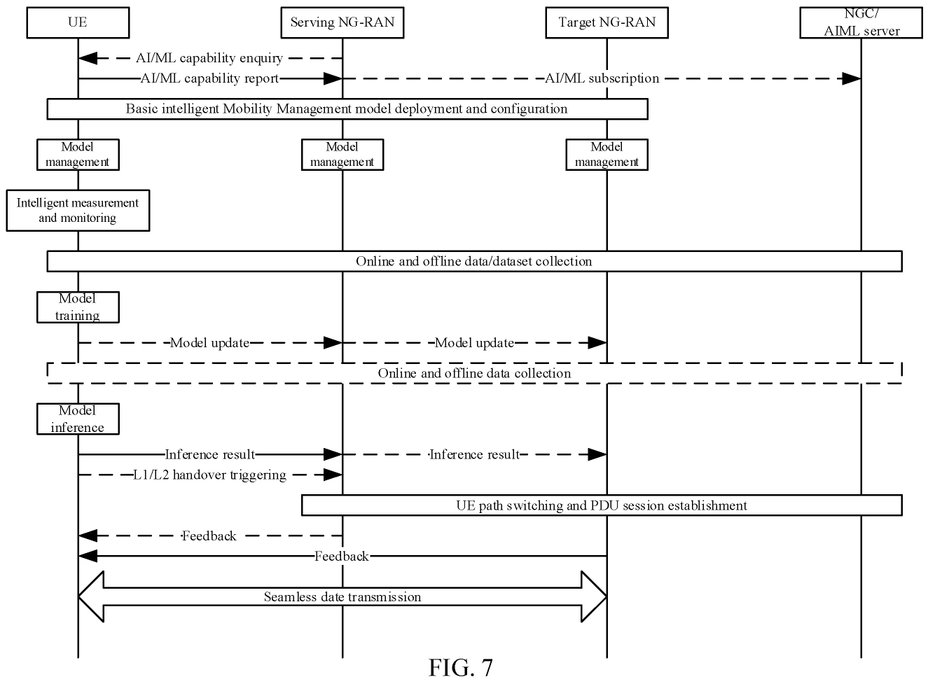

A first embodiment of the present disclosure is as shown in FIG. 7, which depicts implementation scenarios of AI/ML-capable UE triggered handover with UE-side model between the UE 10 and the base station 20 according to the present disclosure. An AI/ML-capable UE is configured to camp either on an intelligent NG-RAN node or legacy NG-RAN node. Here the scope of FIG. 7 is focused on the communication between the AI/ML-capable UE and the intelligent NG-RAN node based on UE-side model. The communication between the non-AI/ML UE and/or legacy NG-RAN node could apply the existing procedure as legacy. In FIG. 7, the UE capability and AI/ML capability information exchange would be initially triggered by the UE or the serving NG-RAN node. An AI/ML capability enquiry including AI/ML-enabled Feature/FG associated information is optionally transmitted from the serving NG-RAN node to the UE. An AI/ML capability report including AI/ML capability information is transmitted by the UE. The UE reports its AI/ML capability (e.g., supported functionality/model structure, applicable conditions) via UE-assistance (e.g., UECapability report, LPP) and then indicates the applicable functionality via real-time report framework (e.g., CSI, UAI, NeedForGap). The AI/ML subscription sent between the UE and NGC/AIML server is transparent to the NG-RAN node. Then at least one of basic AI/ML models (e.g., intelligent mobility management model) is deployed and configured to the UE based on AI/ML capability report. The applicable functionality/model identification is managed by the model management. According to the associated network configuration, the UE performs intelligent monitoring and measuring (e.g., adaptive beam-based measurement) DL signaling and collects the online/offline data (e.g., measurement results, connection history, resource status) for UE-side model training and model inference. Based on the model management, the UE may send the updated AI/ML model including the additional condition to the NG-RAN nodes for AI/ML mobility preparation. The UE may also continue the model training and model inference based on the further online/offline data from the NG-RAN node(s) and/or NGC/AIML server for UE mobility prediction and optimization. The corresponding inference result (e.g., UE location/UE trajectory prediction, target NG-RAN node prediction, RRM measurement prediction, RLF prediction, HO failure prediction) for UE mobility is obtained by the AI/ML model inference at UE side. In some cases, by leveraging the intelligent measurement into the model inference, the inference result is more precise. The inference result may be embedded in a 3GPP signaling (e.g., e.g., NAS, RRC, MAC-CE, UCI, L1, LPP, UAI, Inter-node message) sent to the NG-RAN node(s). Upon the reception of inference result, the serving NG-RAN node and the target NG-RAN node would prepare the associated actions or configurations for the UE. Once the triggering condition of the intelligent handover is met, the associated UE path switching and PDU session establishment is performed between NG-RAN node(s) and NGC/AIML server. The serving NG-RAN node may send feedback information to the UE after the seamless handover preparation is complete. If the inference result is aligned between UE and NG-RAN node(s), at least one feedback information from the network via 3GPP signaling (e.g., NAS, RRC, MAC-CE, DCI, L1, LPP, UAI) is expected to be received by the UE for the following seamless data transmission. In some embodiments, L1/L2-based intelligent handover can be initiated by the UE as described above, and thus will not be repeated herein. When the triggering condition of L1/L2-based intelligent handover is met, a L1/L2 signaling (e.g., UCI, MAC-CE, pre-configured preamble) may be transmitted to inform the NG-RAN node the L1/L2-based handover. In response to the L1/L2 signaling from the UE, the associated NG-RAN node would send a response via a L1/L2 signaling (e.g., DCI, MAC-CE) for L1/L2-based handover and the following seamless data transmission. In the other cases, if the serving NG-RAN node is AI/ML-based while the inferenced target NG-RAN node is a legacy NG-RAN node, upon the reception of inference result as shown in FIG. 7, the serving NG-RAN node would perform the associated actions or configurations for UE seamless handover. When the triggering condition of the intelligent handover is met, the associated UE path switching and PDU session establishment is initiated by the serving NG-RAN node to the target NG-RAN and NGC/AIML server. The target NG-RAN node would apply the radio access with the UE based on the associated PDU session establishment. The incoming data would be proceeded seamlessly.

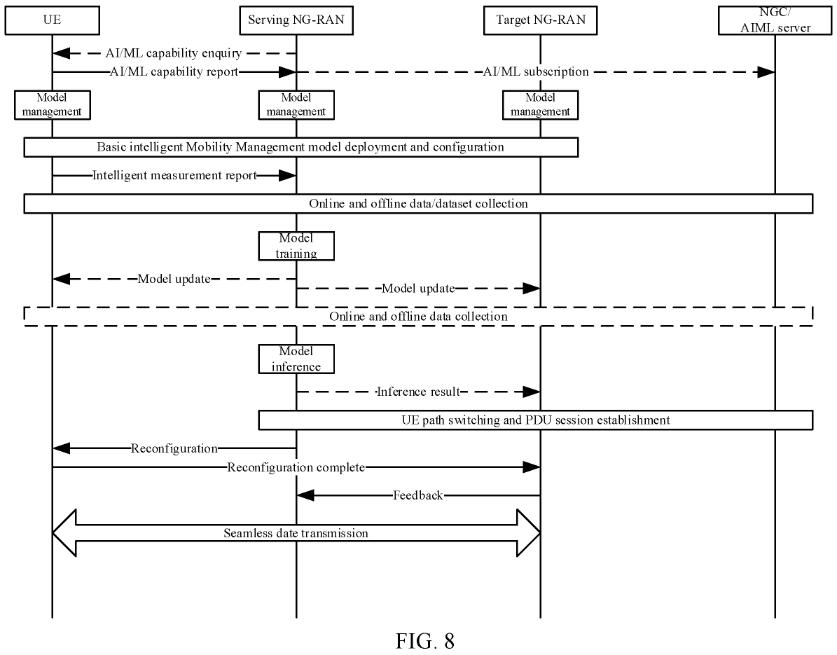

A second embodiment of the present disclosure is as shown in FIG. 8, which depicts implementation scenarios of intelligent NG-RAN node triggered handover with network-side model between the UE 10 and the base station 20 according to the present disclosure. An AI/ML-capable UE is configured to camp either on an intelligent NG-RAN node or legacy NG-RAN node. Here the scope of FIG. 8 is focused on the communication between the AI/ML-capable UE and the intelligent NG-RAN node based on network-side model. The communication between the non-AI/ML UE and/or legacy NG-RAN node could apply the existing procedure as legacy. In FIG. 8, the UE capability and AI/ML capability information exchange would be initially triggered by the UE or the serving NG-RAN node. An AI/ML capability enquiry including AI/ML-enabled Feature/FG associated information is optionally transmitted from the serving NG-RAN node to the UE. An AI/ML capability report including AI/ML capability information is transmitted by the UE. The UE reports its AI/ML capability (e.g., supported functionality/model structure, applicable conditions) via UE-assistance (e.g., UECapability report, LPP) and then indicates the applicable functionality via real-time report framework (e.g., CSI, UAI, NeedForGap). The AI/ML subscription sent between the UE and NGC/AIML server is transparent to the NG-RAN node. The applicable functionality/model identification is managed by the model management. Then at least one of basic AI/ML models (e.g., intelligent mobility management model) is deployed and configured to the UE based on AI/ML capability report and model management. According to the associated network configuration, the UE reports the intelligent measurement report (e.g., adaptive beam-based measurement) to the serving NG-RAN node requested information (e.g., SINR, RSRP, RSRQ of serving cell and neighboring cells, location, velocity). The serving NG-RAN node can also collect the online/offline data (e.g., measurement reports, connection history, resource status) for network-side model training and model inference. Based on the model management, the serving NG-RAN node may send the updated AI/ML model including the additional condition to the UE and neighboring NG-RAN nodes for AI/ML mobility preparation. The serving NG-RAN node may also continue the model training and model inference based on the further online/offline data from the UE, NG-RAN node(s) and/or NGC/AIML server for UE mobility prediction and optimization. The corresponding inference result (e.g., UE location/UE trajectory prediction, target NG-RAN node prediction, RRM measurement prediction, RLF prediction, HO failure prediction) for UE mobility is obtained by the AI/ML model inference at network side. In some cases, by leveraging the intelligent measurement report into the model inference, the inference result is more precise. The inference result may be embedded in a 3GPP signaling (e.g., Reconfiguration, NAS, RRC, MAC-CE, DCI, L1, LPP, UAI, Inter-node message) sent to the target NG-RAN node. The serving NG-RAN node and the target NG-RAN node would prepare the associated actions or configurations for the UE after model inference. Once the triggering condition of the intelligent handover is met, the associated UE path switching and PDU session establishment is performed between NG-RAN node(s) and NGC/AIML server. The serving/target NG-RAN node may send a 3GPP signaling (e.g., Reconfiguration, NAS, RRC, MAC-CE, DCI, L1, LPP, UAI) including the inference result to the UE after the seamless handover preparation is complete. If the inference result is aligned between UE and NG-RAN node(s), some feedback information (e.g., applicable AI/ML functionality, radio access) via 3GPP signaling (e.g., Reconfiguration complete, NAS, RRC, MAC-CE, UCI, L1, LPP, UAI) is transmitted from the UE to the target NG-RAN for the following seamless data transmission. In some embodiments, L1/L2-based intelligent handover can be initiated by the serving NG-RAN node as described above and thus will not be repeated herein. When the triggering condition of L1/L2-based intelligent handover is met, a L1/L2 signaling (e.g., DCI, MAC-CE) may be transmitted to inform the UE the L1/L2-based handover. In response to the L1/L2 signaling from the network, the UE would send a response via a L1/L2 signaling (e.g., UCI, MAC-CE, pre-configured preamble) for L1/L2-based handover and the following seamless data transmission. When the serving NG-RAN node is RAN functional split as shown in FIG. 2, AI/ML model management, model training and model inference are performed in either gNB-CU or gNB-DU. In some cases, model inference can also be executed in the gNB-DU regarding UE location/UE trajectory prediction, RRM measurement prediction, RLF prediction, HO failure prediction. When measuring the received UL signaling strength from the UE (e.g., SINR, RSRP, RSRQ of UE) on gNB-DU, the model inference of gNB-DU can rapidly predict UE location/UE trajectory/RRM measurement/RLF/HO failure and determine whether to trigger L1/L2-based intelligent handover based on the inference result. The gNB-DU may send the inference result to gNB-CU via F1 signaling for model management. Once the triggering condition of the intelligent handover is met and the associated PDU session is established, a L1/L2 signaling (e.g., DCI, MAC-CE) is transmitted to inform the UE the L1/L2-based handover. In response to the L1/L2 signaling from the network, the UE would send a response via a L1/L2 signaling (e.g., UCI, MAC-CE, pre-configured preamble) for L1/L2-based handover and the following seamless data transmission. It would reduce the latency of handover if the gNB-DU can immediately predict and react to the UE trajectory. In the other cases, if the serving NG-RAN node is AI/ML-based while the inferenced target NG-RAN node is a legacy NG-RAN node, the serving NG-RAN node would perform the associated actions or configurations for the UE after network-side model inference as shown in FIG. 8. When the triggering condition of the intelligent handover is met, the associated UE path switching and PDU session establishment is initiated by the serving NG-RAN node to the target NG-RAN and NGC/AIML server. The target NG-RAN node would apply the radio access with the UE based on the associated PDU session establishment. The incoming data would be proceeded seamlessly.

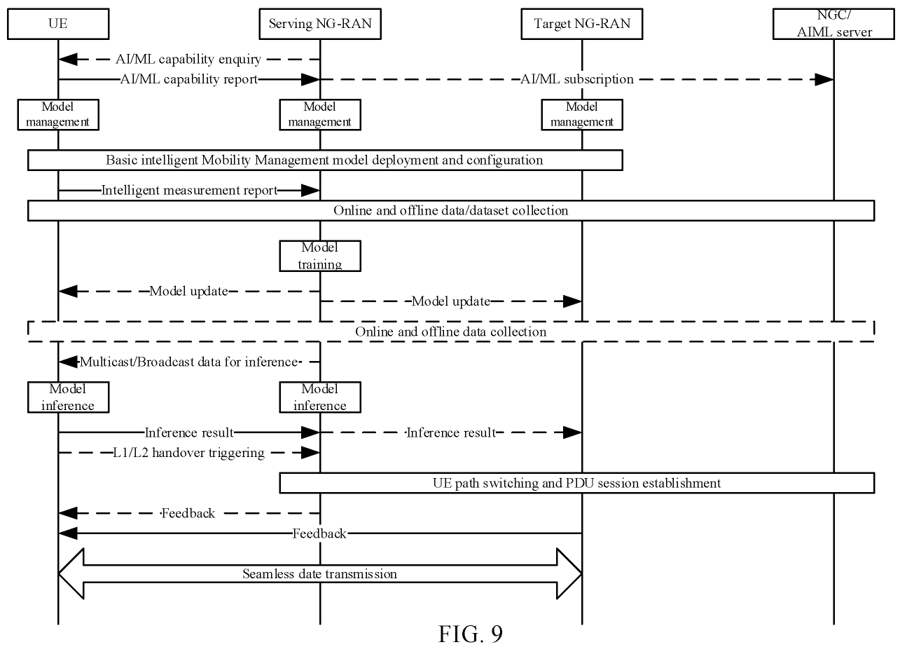

A third embodiment of the present disclosure depicts implementation scenarios of AI/ML-capable UE triggered handover with two-sided model between the UE 10 and the base station 20. Two-sided model refers to an AI/ML model that inference is performed jointly across the UE and the network, e.g., the first part of inference is performed by the UE and then the remaining part is performed by the gNB. FIG. 9 shows an example of AI/ML-capable UE triggered handover with two-sided model but not limited to. An AI/ML-capable UE is configured to camp either on an intelligent NG-RAN node or legacy NG-RAN node. AI/ML model training is performed in the NG-RAN while AI/ML model inference is performed in the UE and optional in the NG-RAN. Here the scope of FIG. 9 is focused on the communication between the AI/ML-capable UE and the intelligent NG-RAN node based on two-sided model. The communication between the non-AI/ML UE and/or legacy NG-RAN node could apply the existing procedure as legacy. In FIG. 9, the UE capability and AI/ML capability information exchange would be initially triggered by the UE or the serving NG-RAN node. An AI/ML capability enquiry including AI/ML-enabled Feature/FG associated information is optionally transmitted from the serving NG-RAN node to the UE. An AI/ML capability report including AI/ML capability information is transmitted by the UE. The UE reports its AI/ML capability (e.g., supported functionality/model structure, applicable conditions) via UE-assistance (e.g., UECapability report, LPP) and then indicates the applicable functionality via real-time report framework (e.g., CSI, UAI, NeedForGap). The AI/ML subscription sent between the UE and NGC/AIML server is transparent to the NG-RAN node. The applicable functionality/model identification is managed by the model management. Then at least one of basic AI/ML models (e.g., intelligent mobility management model) is deployed and configured to the UE based on AI/ML capability report and model management. According to the associated network configuration, the UE reports the intelligent measurement report (e.g., adaptive beam-based measurement) to the serving NG-RAN node requested information (e.g., SINR, RSRP, RSRQ of serving cell and neighboring cells, location, velocity). The serving NG-RAN node can also collect the online/offline data (e.g., measurement reports, connection history, resource status) for two-side model training and model inference. Based on the model management, the serving NG-RAN node may send the updated AI/ML model including the additional condition to the UE and neighboring NG-RAN nodes for AI/ML mobility preparation. The serving NG-RAN node may also continue the model training and optional model inference based on the further online/offline data from the UE, NG-RAN node(s) and/or NGC/AIML server for UE mobility prediction and optimization. The online/offline data from the network can also be collected for UE-part of two-sided model inference. In some embodiments, the network may transmit multicast and broadcast service (MBS) data as the inferenced input at UE-part of two-sided model. By using UE distributed computing and UE-part of two-sided model inference can be considered to increase AI/ML model accuracy and decrease data transmission latency. The corresponding inference result (e.g., UE location/UE trajectory prediction, target NG-RAN node prediction, RRM measurement prediction, RLF prediction, HO failure prediction) for UE mobility is obtained by the two-side AI/ML model inference. In some cases, by leveraging the intelligent measurement into the model inference, the inference result is more precise. The inference result may be embedded in a 3GPP signaling (e.g., e.g., NAS, RRC, MAC-CE, UCI, L1, LPP, UAI, Inter-node message) sent to the NG-RAN node(s). Upon the reception of inference result, the serving NG-RAN node and the target NG-RAN node would prepare the associated actions or configurations for the UE. Once the triggering condition of the intelligent handover is met, the associated UE path switching and PDU session establishment is performed between NG-RAN node(s) and NGC/AIML server. The serving NG-RAN node may send feedback information to the UE after the seamless handover preparation is complete. If the inference result is aligned between UE and NG-RAN node(s), at least one feedback information from the network via 3GPP signaling (e.g., NAS, RRC, MAC-CE, DCI, L1, LPP, UAI) is expected to be received by the UE for the following seamless data transmission. In some embodiments, L1/L2-based intelligent handover can be initiated by the UE as described above and thus will not be repeated herein. When the triggering condition of L1/L2-based intelligent handover is met, a L1/L2 signaling (e.g., UCI, MAC-CE, pre-configured preamble) may be transmitted to inform the NG-RAN node the L1/L2-based handover. In response to the L1/L2 signaling from the UE, the associated NG-RAN node would send a response via a L1/L2 signaling (e.g., DCI, MAC-CE) for L1/L2-based handover and the following seamless data transmission. In the other cases, if the serving NG-RAN node is AI/ML-based while the inferenced target NG-RAN node is a legacy NG-RAN node, upon the reception of inference result as shown in FIG. 9, the serving NG-RAN node would perform the associated actions or configurations for UE seamless handover. When the triggering condition of the intelligent handover is met, the associated UE path switching and PDU session establishment is initiated by the serving NG-RAN node to the target NG-RAN and NGC/AIML server. The target NG-RAN node would apply the radio access with the UE based on the associated PDU session establishment. The incoming data would be proceeded seamlessly.

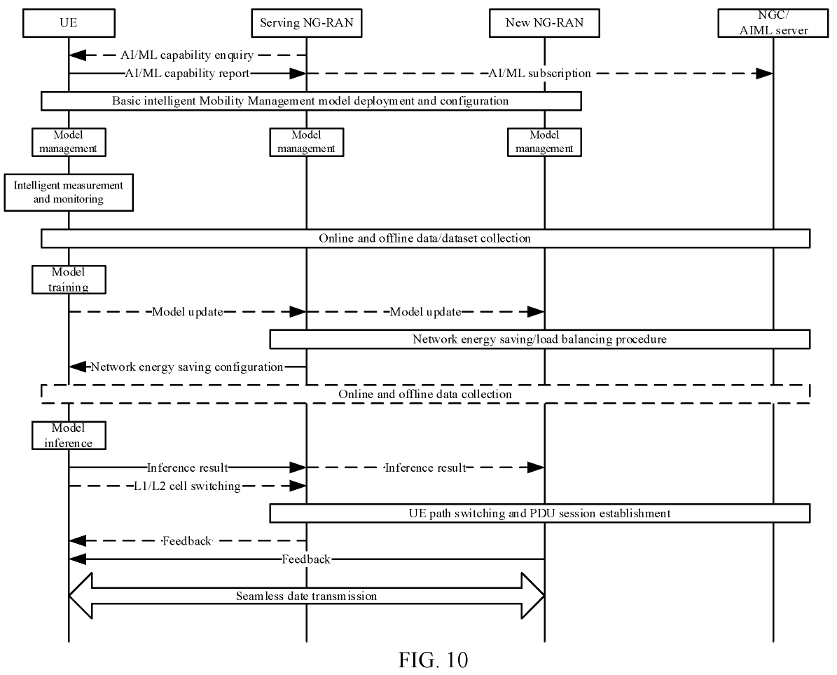

A fourth embodiment of the present disclosure depicts implementation scenarios of AI/ML-capable UE triggered cell switch with UE-sided model between the UE 10 and the base station 20 due to network energy saving or network load balance. For example, when a serving NG-RAN node would like to change the primary carrier configuration (e.g., PCell switching) for network energy saving or load balancing, an intelligent cell switching procedure is necessary. An AI/ML-capable UE is configured to camp either on an intelligent NG-RAN node or legacy NG-RAN node. Here the scope of FIG. 10 is focused on the communication between the AI/ML-capable UE and the intelligent NG-RAN node based on UE-side model. The communication between the non-AI/ML UE and/or legacy NG-RAN node could apply the existing procedure as legacy. In FIG. 10, the UE capability and AI/ML capability information exchange would be initially triggered by the UE or the serving NG-RAN node. An AI/ML capability enquiry including AI/ML-enabled Feature/FG associated information is optionally transmitted from the serving NG-RAN node to the UE. An AI/ML capability report including AI/ML capability information is transmitted by the UE. The UE reports its AI/ML capability (e.g., supported functionality/model structure, applicable conditions) via UE-assistance (e.g., UECapability report, LPP) and then indicates the applicable functionality via real-time report framework (e.g., CSI, UAI, NeedForGap). The AI/ML subscription sent between the UE and NGC/AIML server is transparent to the NG-RAN node. Then at least one of basic AI/ML models (e.g., intelligent mobility management model) is deployed and configured to the UE based on AI/ML capability report. The applicable functionality/model identification is managed by the model management. According to the associated network configuration, the UE performs intelligent monitoring and measuring (e.g., adaptive beam-based measurement) DL signaling and collects the online/offline data (e.g., measurement results, connection history, resource status) for UE-side model training and model inference. Based on the model management, the UE may send the updated AI/ML model including the additional condition to the NG-RAN nodes for AI/ML mobility preparation. The objective of mobility load balance is to distribute load among cells to achieve network energy efficiency. When the network energy saving or load balancing procedure is performed, the serving NG-RAN node transmits the associated network energy saving configuration for the UE. The UE may also continue the model training and model inference based on the further online/offline data (e.g., intelligent measuring, network energy saving or load balancing strategies) from the NG-RAN node(s) and/or NGC/AIML server for UE mobility prediction and optimization. The corresponding inference result (e.g., new NG-RAN node prediction) for cell switching is obtained by the AI/ML model inference at UE side. In some cases, by leveraging the intelligent measurement into the model inference, the inference result is more precise. The inference result may be embedded in a 3GPP signaling (e.g., e.g., NAS, RRC, MAC-CE, UCI, L1, LPP, UAI, Inter-node message) sent to the NG-RAN node(s). Upon the reception of inference result, the serving NG-RAN node and the new NG-RAN node would prepare the associated actions or configurations for the UE. Once the triggering condition of the intelligent cell switching is met, the associated UE path switching and PDU session establishment is performed between NG-RAN node(s) and NGC/AIML server. The serving NG-RAN node may send feedback information to the UE after the seamless cell switching preparation is complete. If the inference result is aligned between UE and NG-RAN node(s), at least one feedback information from the network via 3GPP signaling (e.g., NAS, RRC, MAC-CE, DCI, L1, LPP, UAI) is expected to be received by the UE for the following seamless data transmission. In some embodiments, L1/L2-based intelligent cell switching can be initiated by the UE as described above, and thus will not be repeated herein. When the triggering condition of L1/L2-based intelligent cell switching is met, a L1/L2 signaling (e.g., UCI, MAC-CE, pre-configured preamble) may be transmitted to inform the NG-RAN node the L1/L2-based cell switching. In response to the L1/L2 signaling from the UE, the associated NG-RAN node would send a response via a L1/L2 signaling (e.g., DCI, MAC-CE) for L1/L2-based cell switching and the following seamless data transmission. In the other cases, if the serving NG-RAN node is AI/ML-based while the inferenced new NG-RAN node is a legacy NG-RAN node, upon the reception of inference result as shown in FIG. 10, the serving NG-RAN node would perform the associated actions or configurations for UE seamless cell switching. When the triggering condition of the intelligent cell switching is met, the associated UE path switching and PDU session establishment is initiated by the serving NG-RAN node to the target NG-RAN and NGC/AIML server. The new NG-RAN node would apply the radio access with the UE based on the associated PDU session establishment. The incoming data would be proceeded seamlessly.

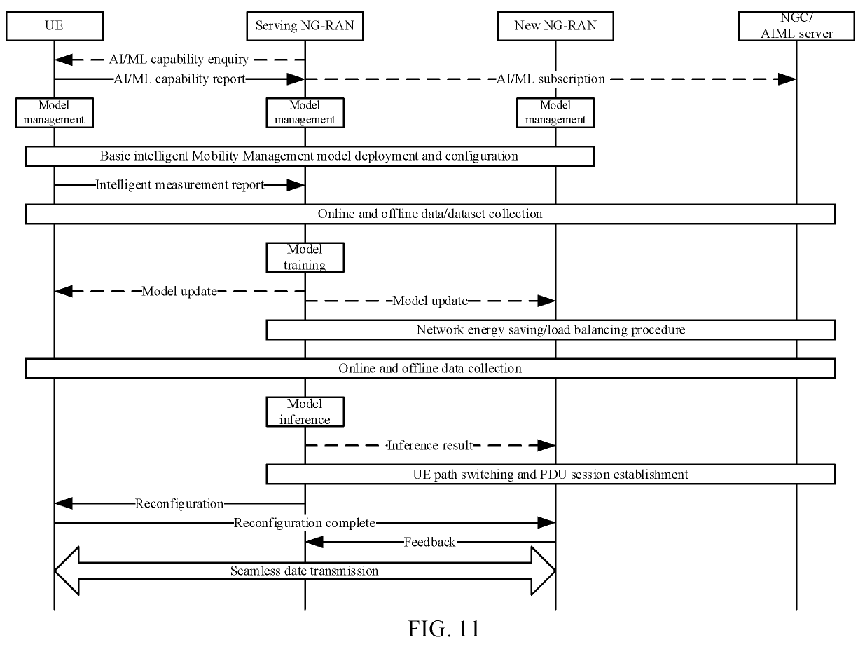

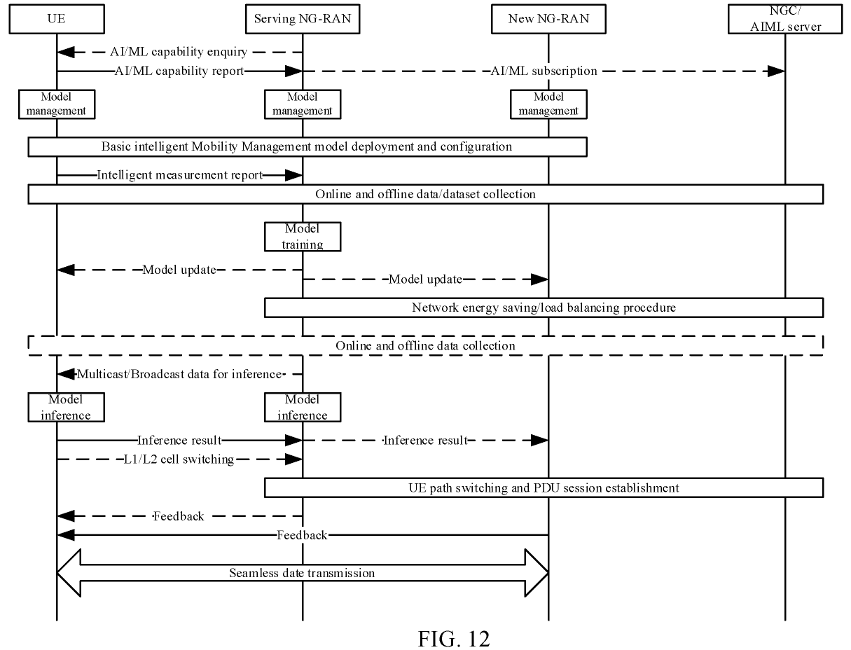

A fifth embodiment of the present disclosure depicts implementation scenarios of intelligent NG-RAN node triggered cell switch with network-sided model between the UE 10 and the base station 20 due to network energy saving or network load balance. For example, when a serving NG-RAN node would like to change the primary carrier configuration (e.g., PCell switching) for network energy saving or load balancing, an intelligent cell switching procedure is necessary. An AI/ML-capable UE is configured to camp either on an intelligent NG-RAN node or legacy NG-RAN node. Here the scope of FIG. 11 is focused on the communication between the AI/ML-capable UE and the intelligent NG-RAN node based on network-sided model. The communication between the non-AI/ML UE and/or legacy NG-RAN node could apply the existing procedure as legacy. In FIG. 11, the UE capability and AI/ML capability information exchange would be initially triggered by the UE or the serving NG-RAN node. An AI/ML capability enquiry including AI/ML-enabled Feature/FG associated information is optionally transmitted from the serving NG-RAN node to the UE. An AI/ML capability report including AI/ML capability information is transmitted by the UE. The UE reports its AI/ML capability (e.g., supported functionality/model structure, applicable conditions) via UE-assistance (e.g., UECapability report, LPP) and then indicates the applicable functionality via real-time report framework (e.g., CSI, UAI, NeedForGap). The AI/ML subscription sent between the UE and NGC/AIML server is transparent to the NG-RAN node. The applicable functionality/model identification is managed by the model management. Then at least one of basic AI/ML models (e.g., intelligent mobility management model) is deployed and configured to the UE based on AI/ML capability report and model management. According to the associated network configuration, the UE reports the intelligent measurement report (e.g., adaptive beam-based measurement) to the serving NG-RAN node requested information (e.g., SINR, RSRP, RSRQ of serving cell and neighboring cells, location, velocity). The serving NG-RAN node can also collect the online/offline data (e.g., measurement reports, connection history, resource status) for network-side model training and model inference. Based on the model management, the serving NG-RAN node may send the updated AI/ML model including the additional condition to the UE and neighboring NG-RAN nodes for AI/ML mobility preparation. The objective of mobility load balance is to distribute load among cells to achieve network energy efficiency. When the network energy saving or load balancing procedure is performed, the serving NG-RAN node may continue the model training and model inference based on the further online/offline data (e.g., UE measurement report, network energy saving or load balancing strategies) from the UE, NG-RAN node(s) and/or NGC/AIML server for UE mobility prediction and optimization. The corresponding inference result (e.g., new NG-RAN node prediction) for cell switching is obtained by the AI/ML model inference at network side. In some cases, by leveraging the intelligent measurement report into the model inference, the inference result is more precise. The inference result may be embedded in a 3GPP signaling (e.g., Inter-node message) sent to the new NG-RAN node. The serving NG-RAN node and the new NG-RAN node would prepare the associated actions or configurations for the UE after model inference. Once the triggering condition of the intelligent cell switching is met, the associated UE path switching and PDU session establishment is performed between NG-RAN node(s) and NGC/AIML server. The serving/new NG-RAN node may send a 3GPP signaling (e.g., Reconfiguration, NAS, RRC, MAC-CE, DCI, L1, LPP, UAI) including the inference result to the UE after the seamless cell switching preparation is complete. If the inference result is aligned between UE and NG-RAN node(s), some feedback information (e.g., applicable AI/ML functionality, radio access) via 3GPP signaling (e.g., Reconfiguration complete, NAS, RRC, MAC-CE, UCI, L1, LPP, UAI) is transmitted from the UE to the new NG-RAN for the following seamless data transmission. In some embodiments, L1/L2-based intelligent cell switching can be initiated by the serving NG-RAN node as described above, and thus will not be repeated herein. When the triggering condition of L1/L2-based intelligent cell switching is met, a L1/L2 signaling (e.g., DCI, MAC-CE) may be transmitted to inform the UE the L1/L2-based cell switching. In response to the L1/L2 signaling from the network, the UE would send a response via a L1/L2 signaling (e.g., UCI, MAC-CE, pre-configured preamble) for L1/L2-based cell switching and the following seamless data transmission. When the serving NG-RAN node is RAN functional split as shown in FIG. 2, AI/ML model management, model training and model inference are performed in either gNB-CU or gNB-DU. In some cases, model inference can also be executed in the gNB-DU regarding UE location/UE trajectory prediction, RRM measurement prediction, RLF prediction, HO failure prediction. When measuring the received UL signaling strength from the UE (e.g., SINR, RSRP, RSRQ of UE) on gNB-DU, the model inference of gNB-DU can rapidly predict UE location/UE trajectory/RRM measurement/RLF/HO failure and determine whether to trigger L1/L2-based intelligent cell switching based on the inference result. The gNB-DU may send the inference result to gNB-CU via F1 signaling for model management. Once the triggering condition of the intelligent cell switching is met and the associated PDU session is established, a L1/L2 signaling (e.g., DCI, MAC-CE) is transmitted to inform the UE the L1/L2-based cell switching. In response to the L1/L2 signaling from the network, the UE would send a response via a L1/L2 signaling (e.g., UCI, MAC-CE, pre-configured preamble) for L1/L2-based cell switching and the following seamless data transmission. It would reduce the latency of cell switching if the gNB-DU can immediately predict and react to the UE trajectory.

In the other cases, if the serving NG-RAN node is AI/ML-based while the inferenced new NG-RAN node is a legacy NG-RAN node, the serving NG-RAN node would perform the associated actions or configurations for the UE after network-side model inference as shown in FIG. 11. When the triggering condition of the intelligent cell switching is met, the associated UE path switching and PDU session establishment is initiated by the serving NG-RAN node to the target NG-RAN and NGC/AIML server. The new NG-RAN node would apply the radio access with the UE based on the associated PDU session establishment. The incoming data would be proceeded seamlessly.

A sixth embodiment of the present disclosure depicts implementation scenarios of AI/ML-capable UE triggered cell switch with two-sided model between the UE 10 and the base station 20 due to network energy saving or network load balance. For example, when a serving NG-RAN node would like to change the primary carrier configuration (e.g., PCell switching) for network energy saving or load balancing, an intelligent cell switching procedure is necessary. Two-sided model refers to an AI/ML model that inference is performed jointly across the UE and the network, e.g., the first part of inference is performed by the UE and then the remaining part is performed by the gNB. FIG. 12 shows an example of AI/ML-capable UE triggered cell switch with two-sided model, but not limited to. An AI/ML-capable UE is configured to camp either on an intelligent NG-RAN node or legacy NG-RAN node. AI/ML model training is performed in the NG-RAN while AI/ML model inference is performed in the UE and optional in the NG-RAN. Here the scope of FIG. 12 is focused on the communication between the AI/ML-capable UE and the intelligent NG-RAN node based on two-sided model. The communication between the non-AI/ML UE and/or legacy NG-RAN node could apply the existing procedure as legacy. In FIG. 12, the UE capability and AI/ML capability information exchange would be initially triggered by the UE or the serving NG-RAN node. An AI/ML capability enquiry including AI/ML-enabled Feature/FG associated information is optionally transmitted from the serving NG-RAN node to the UE. An AI/ML capability report including AI/ML capability information is transmitted by the UE. The UE reports its AI/ML capability (e.g., supported functionality/model structure, applicable conditions) via UE-assistance (e.g., UECapability report, LPP) and then indicates the applicable functionality via real-time report framework (e.g., CSI, UAI, NeedForGap). The AI/ML subscription sent between the UE and NGC/AIML server is transparent to the NG-RAN node. The applicable functionality/model identification is managed by the model management. Then at least one of basic AI/ML models (e.g., intelligent mobility management model) is deployed and configured to the UE based on AI/ML capability report and model management. According to the associated network configuration, the UE reports the intelligent measurement report (e.g., adaptive beam-based measurement) to the serving NG-RAN node requested information (e.g., SINR, RSRP, RSRQ of serving cell and neighboring cells, location, velocity). The serving NG-RAN node can also collect the online/offline data (e.g., measurement reports, connection history, resource status) for two-side model training and model inference. Based on the model management, the serving NG-RAN node may send the updated AI/ML model including the additional condition to the UE and neighboring NG-RAN nodes for AI/ML mobility preparation. The objective of mobility load balance is to distribute load among cells to achieve network energy efficiency. When the network energy saving or load balancing procedure is performed, the serving NG-RAN node may continue the model training and optional model inference based on the further online/offline data (e.g., UE measurement report, network energy saving or load balancing strategies) from the UE, NG-RAN node(s) and/or NGC/AIML server for UE mobility prediction and optimization. The online/offline data from the network can also be collected for UE-part of two-sided model inference. In some embodiments, the network may transmit multicast and broadcast service (MBS) data as the inferenced input at UE-part of two-sided model. By using UE distributed computing and UE-part of two-sided model inference can be considered to increase AI/ML model accuracy and decrease data transmission latency. The corresponding inference result (e.g., new NG-RAN node prediction) for cell switching is obtained by the two-side AI/ML model inference. In some cases, by leveraging the intelligent measurement into the model inference, the inference result is more precise. The inference result may be embedded in a 3GPP signaling (e.g., e.g., NAS, RRC, MAC-CE, UCI, L1, LPP, UAI, Inter-node message) sent to the NG-RAN node(s). Upon the reception of inference result, the serving NG-RAN node and the new NG-RAN node would prepare the associated actions or configurations for the UE. Once the triggering condition of the intelligent cell switching is met, the associated UE path switching and PDU session establishment is performed between NG-RAN node(s) and NGC/AIML server. The serving NG-RAN node may send feedback information to the UE after the seamless cell switching preparation is complete. If the inference result is aligned between UE and NG-RAN node(s), at least one feedback information from the network via 3GPP signaling (e.g., NAS, RRC, MAC-CE, DCI, L1, LPP, UAI) is expected to be received by the UE for the following seamless data transmission. In some embodiments, L1/L2-based intelligent handover can be initiated by the UE as described above, and thus will not be repeated herein. When the triggering condition of L1/L2-based intelligent cell switching is met, a L1/L2 signaling (e.g., UCI, MAC-CE, pre-configured preamble) may be transmitted to inform the NG-RAN node the L1/L2-based cell switching. In response to the L1/L2 signaling from the UE, the associated NG-RAN node would send a response via a L1/L2 signaling (e.g., DCI, MAC-CE) for L1/L2-based cell switching and the following seamless data transmission. In the other cases, if the serving NG-RAN node is AI/ML-based while the inferenced new NG-RAN node is a legacy NG-RAN node, upon the reception of inference result as shown in FIG. 12, the serving NG-RAN node would perform the associated actions or configurations for UE seamless cell switching. When the triggering condition of the intelligent cell switching is met, the associated UE path switching and PDU session establishment is initiated by the serving NG-RAN node to the target NG-RAN and NGC/AIML server. The new NG-RAN node would apply the radio access with the UE based on the associated PDU session establishment. The incoming data would be proceeded seamlessly.

Commercial interests for some embodiments are as follows. 1. solving issues in the prior art. 2. realizing intelligent mobility management. 3. preventing frequent handover or cell switch. 4. realizing energy saving or load balancing. 5. providing a good communication performance. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present disclosure further provides a wireless communication method for applying AI/ML functionalities, executable by a base station (BS), the method including receiving from a UE in a network artificial intelligence (AI)/machine learning (ML) capability information, wherein the AI/ML capability information indicates supported AI/ML functionalities at UE side; communicating with the UE to decide applicable AI/ML functionality for AI/ML feature/feature group (FG), at least based on the AI/ML capability information; and performing at least one AI/ML functionality activation at a given time to trigger AI/ML inference for seamless data transmission. Details can be referred to each of the methods of the embodiment of the present disclosure. For brevity, details will not be described herein again.

The embodiment of the present disclosure further provides a method for managing mobility of a user equipment (UE) in a network, the method including configuring, by a base station, a UE with an intelligent measurement configuration for the UE to start data collection; receiving, by the base station, from the UE an intelligent measurement report triggered based on measured measurements and the intelligent measurement configuration; performing, by the base station, artificial intelligence (AI)/machine learning (ML) inference based on the intelligent measurement report to obtain inference result; and performing, by the base station, handover or cell switch when a triggering condition is met. Details can be referred to each of the methods of the embodiment of the present disclosure. For brevity, details will not be described herein again.

The embodiment of the present disclosure further provides a user equipment including a memory and a processor coupled to the memory, the processor configured to call and run program instructions stored in a memory, to execute each of the methods of the embodiment of the present disclosure. For brevity, details will not be described herein again.

The embodiment of the present disclosure further provides a base station including a memory and a processor coupled to the memory, the processor configured to call and run program instructions stored in a memory, to execute each of the methods of the embodiment of the present disclosure. For brevity, details will not be described herein again.

The embodiment of the present disclosure further provides a computer readable storage medium for storing a computer program. The computer readable storage medium enables a computer to execute corresponding processes implemented by the UE/BS in each of the methods of the embodiment of the present disclosure. For brevity, details will not be described herein again.

The embodiment of the present disclosure further provides a computer program product including computer program instructions. The computer program product enables a computer to execute corresponding processes implemented by the UE/BS in each of the methods of the embodiment of the present disclosure. For brevity, details will not be described herein again.

The embodiment of the present disclosure further provides a computer program. The computer program enables a computer to execute corresponding processes implemented by the UE/BS in each of the methods of the embodiment of the present disclosure. For brevity, details will not be described herein again.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.) , mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor including the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for applying AI/ML functionalities, executable by a user equipment (UE), the method comprising:
sending, by a UE in a network, artificial intelligence (AI)/machine learning (ML) capability information to the network, wherein the AI/ML capability information indicates supported AI/ML functionalities at UE side;
communicating with the network to decide applicable AI/ML functionality for AI/ML feature/feature group (FG), at least based on the AI/ML capability information; and
performing at least one AI/ML functionality activation at a given time to trigger AI/ML inference for mobility management and seamless data transmission.

2. The method of claim 1, wherein the AI/ML capability information is sent by the UE upon reception of an AI/ML capability enquiry including AI/ML-enabled Feature/FG associated information.

3. The method of claim 1, wherein the AI/ML capability information includes applicable condition of the AI/ML functionality.

4. The method of claim 1, further comprising:
receiving applicable condition from the network in response to the AI/ML capability information.

5. The method of claim 1, wherein the applicable AI/ML functionality is decided by the UE or the network based on the AI/ML capability information and applicable condition.

6. The method of claim 1, further comprising:
reporting the applicable AI/ML functionality via real-time report framework based on the AI/ML capability information and applicable condition.

7. The method of claim 1, further comprising:
receiving an AI/ML configuration associated with the applicable AI/ML functionality.

8. The method of claim 1, wherein at least one of selection, (de)activation, switching and fallback of the AI/ML functionality is indicated by the UE or the network.

9. The method of claim 1, wherein the AI/ML functionality corresponds to an AI/ML model associated with at least one of network configuration and additional condition of the AI/ML Feature/FG.

10. The method of claim 9, wherein the AI/ML model is a UE-side model that the AI/ML inference is performed entirely at UE side.

11. The method of claim 9, wherein the AI/ML model is a network-side model that the AI/ML inference is performed entirely at network side.

12. The method of claim 9, wherein the AI/ML model is a two-sided model that the AI/ML inference is performed jointly across the UE and the network.

13. The method of claim 9, wherein the AI/ML model is identified at UE side or network side via model ID, and the model ID is used for at least one of the following model operations: model selection, model activation, model deactivation, model switch and model fallback.

14. The method of claim 9, wherein inference result of the AI/ML model from the UE, a centralized unit (CU) or a distributed unit (DU) of a base station is used to trigger layer 1 (L1)/layer 2 (L2)-based intelligent mobility management procedure.

15. The method of claim 1, further comprising:
triggering the AI/ML inference based on the inference data and at least one condition, wherein the at least one condition comprises inference request or AI/ML model transfer.

16. The method of claim 1, wherein the AI/ML functionality is activated for mobility associated with a mobility management model, and wherein the mobility management comprises handover or cell switch.

17. The method of claim 1, wherein the AI/ML functionality is applicable for an AI/ML feature group associated with mobility management.

18. A wireless communication method for applying AI/ML functionalities, executable by a base station (BS), the method comprising:
receiving from a UE in a network artificial intelligence (AI)/machine learning (ML) capability information, wherein the AI/ML capability information indicates supported AI/ML functionalities at UE side;
communicating with the UE to decide applicable AI/ML functionality for AI/ML feature/feature group (FG), at least based on the AI/ML capability information; and
performing at least one AI/ML functionality activation at a given time to trigger AI/ML inference for mobility management and seamless data transmission.

19. A user equipment (UE), comprising a memory and a processor coupled to the memory, the processor configured to call and run program instructions stored in a memory to execute the method of claim 1.

20. A base station (BS), comprising a memory and a processor coupled to the memory, the processor configured to call and run program instructions stored in a memory to execute the method of claim 18.
